(19) United States
(12) Patent Application Publication
(10) Pub. No.: US 2013/0070862 A1
(43) Pub. Date: Mar. 21, 2013

(54) VIDEO COMPRESSION ENCODING DEVICE IMPLEMENTING AN APPLIED MOTION COMPENSATION TECHNIQUE USING A SELECTIVE MOTION SEARCH, AND METHOD FOR DETERMINING SELECTIVE MOTION COMPENSATION

(71) Applicants: Jean Koh, Seongnam-si (KR); Jae Deok An, Uijeongbu-si (KR); Seong Hoon Kim, Seoul (KR); In Kwon Kim, Gwangmyeong-si (KR)

(72) Inventors: Jean Koh, Seongnam-si (KR); Jae Deok An, Uijeongbu-si (KR); Seong Hoon Kim, Seoul (KR); In Kwon Kim, Gwangmyeong-si (KR)

(73) Assignee: GALAXIA COMMUNICATIONS CO., LTD., Seoul (KR)

(21) Appl. No.: 13/699,083

(22) PCT Filed: May 20, 2010
(86) PCT No.: PCT/KR10/03183

§ 371 Date: Nov. 20, 2012

(51) Int. Cl. H04N 7/26

(52) U.S. Cl. 375/240.29; 375/E07.193

(57) ABSTRACT

Disclosed is a method for generating a motion search area of a video CODEC for implementing motion compensation through motion estimation as a unit of block. Compression efficiency can be further improved by additionally creating various reference frames by an intentional motion blur and a deblur filter, filtering a motion search area using a motion blur filter and a motion deblur filter as a unit of block which is a unit of video coding, and selecting reference frame having small residual frame data during execution of the motion estimation as final reference frames among original reference frames and various reference frames (motion search areas) additionally created.

### BACKGROUND OF THE INVENTION

1. Field of the Invention

The present invention relates to a method for generating a motion search area of a video CODEC for implementing motion compensation through motion estimation as a unit of block, and more particularly, to a method that can increase compression efficiency of a video CODEC by additionally creating a motion search area to which motion blur noise occurring due to motion of a video input apparatus such as a camera, or motion of an object is added, and a motion search area from which the motion blur noise is removed besides an existing or original motion search area for use in motion estimation, and compensating for motion by selecting a motion search area having better efficiency from among a plurality of motion search areas.

2. Prior Art

In general, as shown in FIG. 1, a video coder to which a motion compensation method using motion estimation is applied includes a subtractor 10 for obtaining a difference signal between an input video (frames) and a motion-compensated frame signal; a transform unit 20 for transforming the difference signal obtained by the subtractor 10 in accordance with a predetermined function; a quantization unit 30 for quantizing a frame signal transformed by the transform unit 20; an entropy coding unit 40 for coding frame information quantized by the quantization unit 30; and a motion compensation means for compensating for motion by performing inverse signal processing on the frame signal quantized by the quantization unit 30.

The motion compensation means includes an inverse quantization unit 50 for performing inverse quantization on the frame signal quantized by the quantization unit 30; an inverse transform unit 60 for performing an inverse transform on signal transformed by the transform unit 20; an adder 70 for generating a frame reconstructed from an inverse transformed frame by the inverse transform unit 60 by adding a motion-compensated frame; a frame memory 80; a motion estimation unit 90 for generating a motion vector by estimating motion from a reference frame of a previous frame or a future frame to be inputted; and a motion compensation unit 100 for compensating for motion by using the motion vector generated from the motion estimation unit 90.

In the general video coding method, a video is classified into an intra-frame and an inter-frame as a unit of frame. Intra-macroblock coding is performed on the intra-frame. A macroblock having much better efficiency between an intra-macroblock and an inter-macroblock is selected from the inter-frame.

Inter-macroblock coding increases compression efficiency by selecting a motion search area from a frame before or after a currently input frame, performing motion estimation on the selected motion search area, and sequentially performing a transform, a quantization, and entropy coding on a residual frame.

When the next frame is necessary the reference frame, the reconstructed frame is generated through the inverse quantization and the inverse transform before the entropy coding, and the generated reconstructed frame is used as the reference frame.

In the case of H.264, a higher-definition reference frame can be obtained by configuring a deblocking filter after the inverse transform unit 60.

Here, the transform of the transform unit 20 is used a Discrete Cosine Transform (DCT) in the case of Moving Picture Experts Group 4 (MPEG4) part 2 is used. An entropy coding of the entropy coding unit 40 is used Variable Length Coding (VLC).

In the case of H.264/Advanced Video Coding (H.264/AVC), an integer transform may be used as the transform, and context-based adaptive VLC (CAVLC) or context-based adaptive binary arithmetic coding (CABAC) may be used as the entropy coding. Also, the deblocking filter may be used.

In general, in respective frame of resultant images captured by a video apparatus, motion blurs of a certain direction may occur in the entire frame in a considerable number of frames due to the number of frames per second (FPS) of a camera, external factors such as shutter speed, movement of a photographing apparatus, shaking of the hand and the like, or to movement or the like of an object to be photographed. Also, motion blurs may occur only in a specific portion. Because there is no method to cope with the motion blurs as described above, video compression efficiency is degraded.

### SUMMARY OF THE INVENTION

Motion blurs occur in a video or frame due to external factors such as motion of a photographing apparatus upon photographing by a video apparatus, or motion of an object to be photographed. However, motion blurs may occur in the entire video or frame, or in only a specific portion.

Therefore, the objective of present invention is to increase much higher compression efficiency than to be filtered the entire frame by filtering a motion search area using a motion blur filter and a motion deblur filter in units of blocks, each of which is a unit of video coding, generating a plurality of motion search areas in units of blocks, and selecting a desired motion search area from among the generated motion search areas.

In accordance with an aspect of the present invention, there is provided a video coder for performing motion estimation using a reference frame, including:

one or more motion blur filters and one or more motion deblur filters to generate additional motion search areas of the reference frame in accordance with motion degrees and angles of original motion search areas as a unit of block for the motion estimation; frame memories configured for the motion blur filter and the motion deblur filter respectively; a search area generation control means to generate additional motion search areas of a blur mode with respect to the original motion search areas by selecting the motion blur filter and the motion deblur filter in accordance with a predetermined blur mode; a motion estimation and mode selection control means to respectively perform motion estimation about all of the generated motion search areas and the generated motion search areas and new added motion search areas, and select the blur mode to be applied to motion compensation by calculating costs of motion estimation processes; and a motion compensation means to perform motion compensation in accordance with the selected blur mode from the motion estimation and mode selection control means.

In the coder, a motion estimation and compensation process includes: a blur mode selection process of setting a blur mode for generating additional motion search areas in accordance with motion degrees and angles of motion search areas of an original reference frame, and selecting the motion blur filter and the deblur filter in accordance with the set blur mode; a filtering process of generating the motion search areas using the motion blur filter and the motion deblur filter in accordance with the selected blur mode; a motion estimation process of performing motion estimation about the motion search areas of the original reference frame and the motion search areas generated through the filtering process; and a motion compensation process of compensating for motion by comparing costs occurring after the motion estimation, and selecting a blur mode having a minimum value.

In accordance with another aspect of the present invention, there is provided a video decoder for compensating for motion, including: a filter selection control means to extract blur mode information from a decoded frame signal, and generate and control motion search areas by selecting a motion blur filter or a motion deblur filter in accordance with the extracted blur mode information; one or more motion blur filters and one or more motion deblur filters to generate the motion search areas; frame memories configured for the motion blur filter and the motion deblur filter respectively; and a motion compensation means for compensating for motion in accordance with motion information extracted from the decoded frame signal and the generated motion search areas.

In the decoder, a motion compensation process includes: a process of extracting the blur mode from the decoded frame signal; a process of generating the motion search areas through the motion blur filter or the motion deblur filter in accordance with information regarding the extracted blur mode; and a process of compensating for motion in accordance with the generated motion search areas.

The present invention can further reduce temporal redundancy by increasing and decreasing the phenomenon of motion blur present in most of the reference frames used for motion estimation and compensation with respect to motion search areas of a block-unit reference frame in order to reduce temporal redundancy in a current video CODEC, and then can increase compression efficiency of a coder by effectively reducing a bit generation amount.

The present invention is not limited only to MPEG4 and H.264/AVC as described in the above-described examples. The present invention can be applied to all CODECs having various algorithms even in entropy coding such as DCT, Wavelet in terms of a transform as an algorithm applicable to all video CODECs that performs inter estimation.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a configuration of a general video coder;

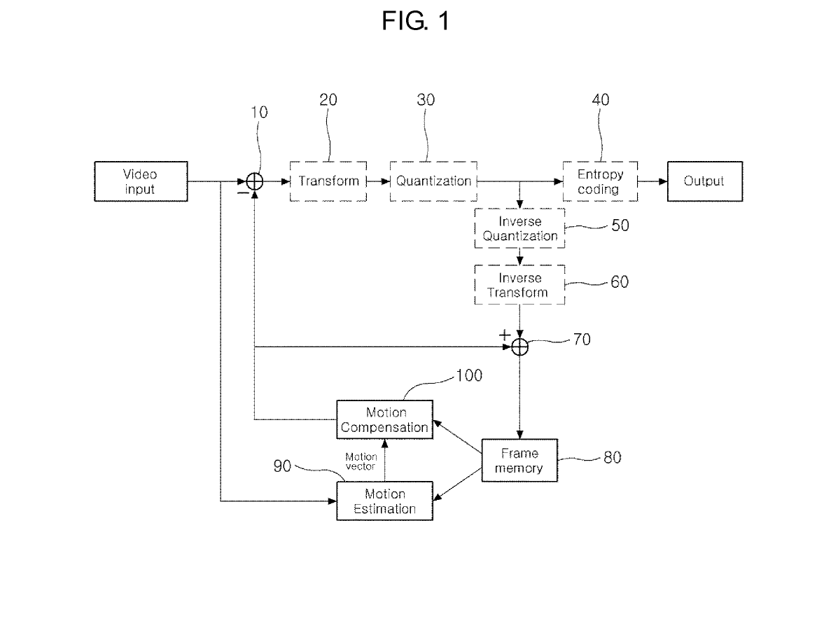

FIG. 2 is a block diagram illustrating a configuration of a video compression coding device applied with a motion compensation technique using a selective motion search area according to an exemplary embodiment of the present invention;

FIG. 3 is a diagram illustrating a process of a selective motion search area determination method for motion compensation according to an exemplary embodiment of the present invention; and

FIG. 4 is a block diagram illustrating a configuration of a video compression decoding device applied with a motion compensation technique using a selective motion search area according to an exemplary embodiment of the present invention.

### DETAILED DESCRIPTION OF EXEMPLARY EMBODIMENTS

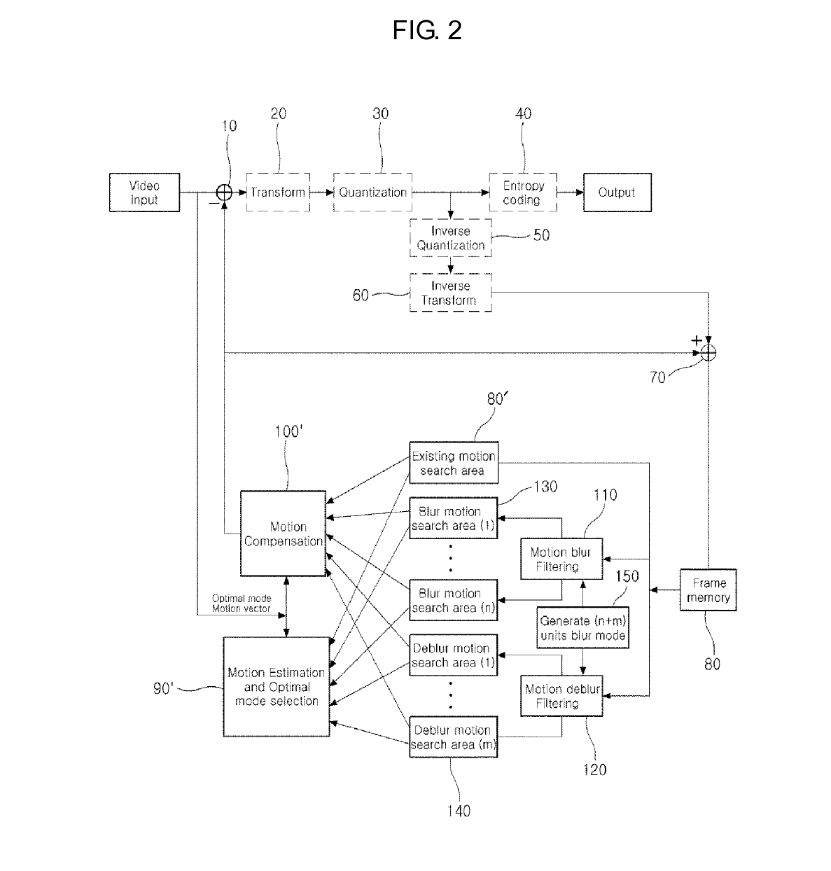

First of all, a video compression coding device applied with a motion compensation technique using a selective reference frame according to an exemplary embodiment of the present invention will be described with reference to FIG. 2. Hereinafter, the same reference numbers are used throughout the drawings to refer to the same or like parts.

The video compression coding device includes a subtractor 10 to obtain a difference signal between an input video (frames) and a motion-compensated frame signal; a transform unit 20 to transform the difference signal obtained by the subtractor 10 in accordance with a predetermined function; a quantization unit 30 to quantize a frame signal transformed by the transform unit 20; an entropy coding unit 40 to code frame information quantized by the quantization unit 30; and a motion compensation means to compensate for motion by performing inverse signal processing about the frame signal quantized by the quantization unit 30.

The motion compensation means includes an inverse quantization unit 50 to perform inverse quantization about the frame signal quantized by the quantization unit 30; an inverse transform unit 60 to perform an inverse transform on the signal transformed by the transform unit 20; an adder 70 to generate a reconstructed frame from a transformed frame after the inverse transform by the inverse transform unit 60 by adding a motion-compensated frame; a frame memory 80; one or more motion blur filters 110 and one or more deblur filters 120 to generate additional motion search areas in accordance with motion degrees and angles of block-unit motion search areas of an original reference frame after the inverse transform by the inverse transform unit 60; blur frame memories 130 and deblur frame memories 140 configured for the motion blur filter 110 and the motion deblur filter 120 respectively; a motion search area generation control unit 150 to generate motion search areas by selecting the motion blur filter and the motion deblur filter in accordance with a predetermined mode; a motion estimation and mode selection control unit 90′ to perform motion estimation about all of the generated motion search areas received from the blur frame memories 130 and the deblur frame memories 140, and the motion search areas of the original reference frame received from the frame memory 80, calculate costs of motion estimation processes, and select a mode to be applied to motion compensation; and a motion compensation unit 100′ to compensate for motion in accordance with the mode selected by the motion estimation and mode selection control unit 90′.

An operation process according to the exemplary embodiment of the present invention will be described in detail as follows.

As described in the Prior Art, a frame is classified into an intra-frame and an inter-frame as a unit of a frame of video. Intra-macroblock coding is performed on the intra-frame. A macroblock having much better efficiency between an intra-macroblock and an inter-macroblock is selected from the inter-frame.

Inter-macroblock coding increases compression efficiency by setting a frame before or after a currently input frame as a reference frame, selecting a motion search area from the reference frame, performing motion estimation on the selected motion search area, and sequentially performing a transform, a quantization, and entropy coding on a residual frame.

In this case, in consideration of the fact that compression efficiency may be decreased by motion blurring, which may be shown in the reference frame, a motion estimation and compensation process according to an exemplary embodiment of the present invention is aimed at achieving motion compensation using a motion estimation value for a motion search area having small residual frame data by performing intentional motion blur and deblur filtering on motion search areas as a unit of block of a reference frame to create additional motion search areas as a unit of a block, and performing motion estimation on the motion search areas including original motion search areas.

This enables compression efficiency to be increased by performing motion blur and deblur filtering on motion search areas as a unit of a block, each of which is a unit of video coding, instead of the entire reference frame, in consideration of the fact that motion blurring may occur in the entire frame or only in a specific portion.

The motion search area generation control unit 150 generates blur/deblur modes by selecting the motion blur filter 110 and the motion deblur filter 120 according to an internally set program mode.

Information regarding the blur mode includes information regarding a motion magnitude (length or strength), a motion direction, and a type of filter. Blur/deblur modes for (n+m) units are generated by selecting n motion blur filters 110 and m motion deblur filters 120.

The motion magnitude (length or strength) defines the number of filter taps to be used in a filter, the motion direction refers to a horizontal, vertical, or orthogonal direction of a filter tap (supportable in all directions of 360 degrees), and information regarding the filter type indicates whether a uniform filter or a Point Spread Function (PSF) filter is used in accordance with the filter tap.

A reconstructed frame generated through the inverse transform unit 60 is transferred to the motion blur filter 110 and the motion deblur filter 120 through the frame memory 80, and filtered by the motion blur filter 110 and the motion deblur filter 120 selected as described above, so that a plurality of motion search areas are generated with respect to a block-unit motion search area of the reconstructed frame.

Thereafter, the motion estimation and mode selection control unit 90′ selects an optimal mode by performing motion estimation on motion search areas transferred from the frame memory 80, and motion search areas transferred from the blur frame memories (blur motion search area memories) 130 and the deblur frame memories (deblur motion search area memories) 140 storing the motion search areas after filtering by the motion blur filter 110 and the motion deblur filter 120, and calculating costs of execution steps.

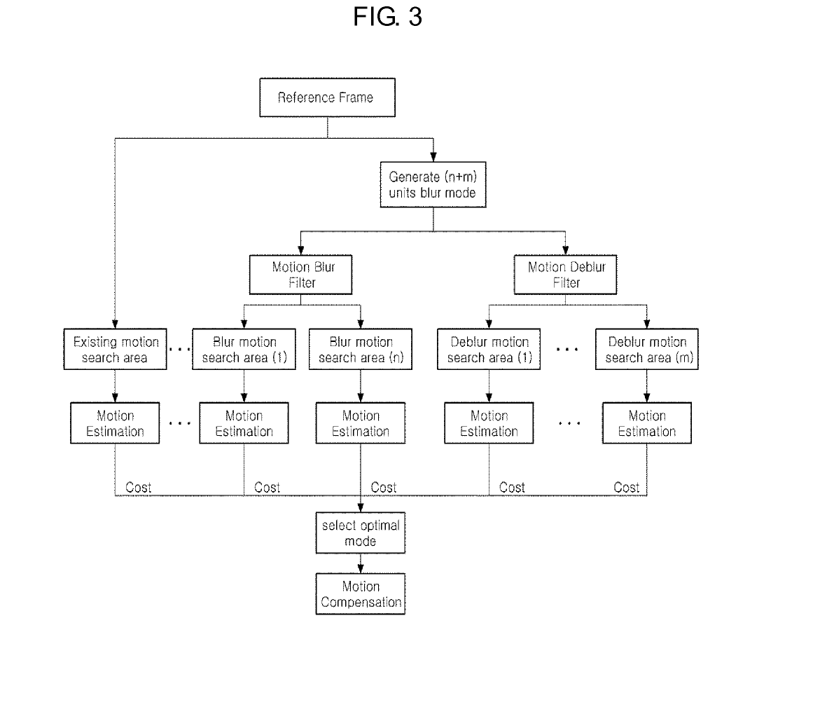

FIG. 3 illustrates a motion estimation and compensation process using a reference frame as described above.

The motion estimation and compensation process includes: a blur mode selection process of selecting the motion blur filter and the motion deblur filter to generate additional motion search areas in accordance with motion magnitudes (lengths or intensity) and motion directions of motion search areas of an original reference frame; a filtering process of generating the motion search areas by the motion blur filter and the motion deblur filter in accordance with a selected blur mode; a motion estimation process of performing motion estimation on the original motion search areas and the motion search areas generated through the filtering process; and a motion compensation process of compensating for motion by comparing costs occurring after the motion estimation and selecting a blur mode having a minimum value.

In blur mode generation, the motion search area generation control unit 150 sets a motion magnitude (length or strength), a motion direction, and a type of filter for an original motion search area, sets the blur mode for n units in the motion blur filter 110, and sets the deblur mode for m units in the motion deblur filter 120.

Mode-specific blurred motion search areas are created in the blur mode set for the n units, and mode-specific deblurred motion search areas are created in the deblur mode set for the m units.

In the motion estimation and mode selection control unit 90′, (n+m+1) motion estimation operations are performed with existing or original motion search areas, costs of execution steps are calculated, and a low-cost mode is selected as an optimal mode.

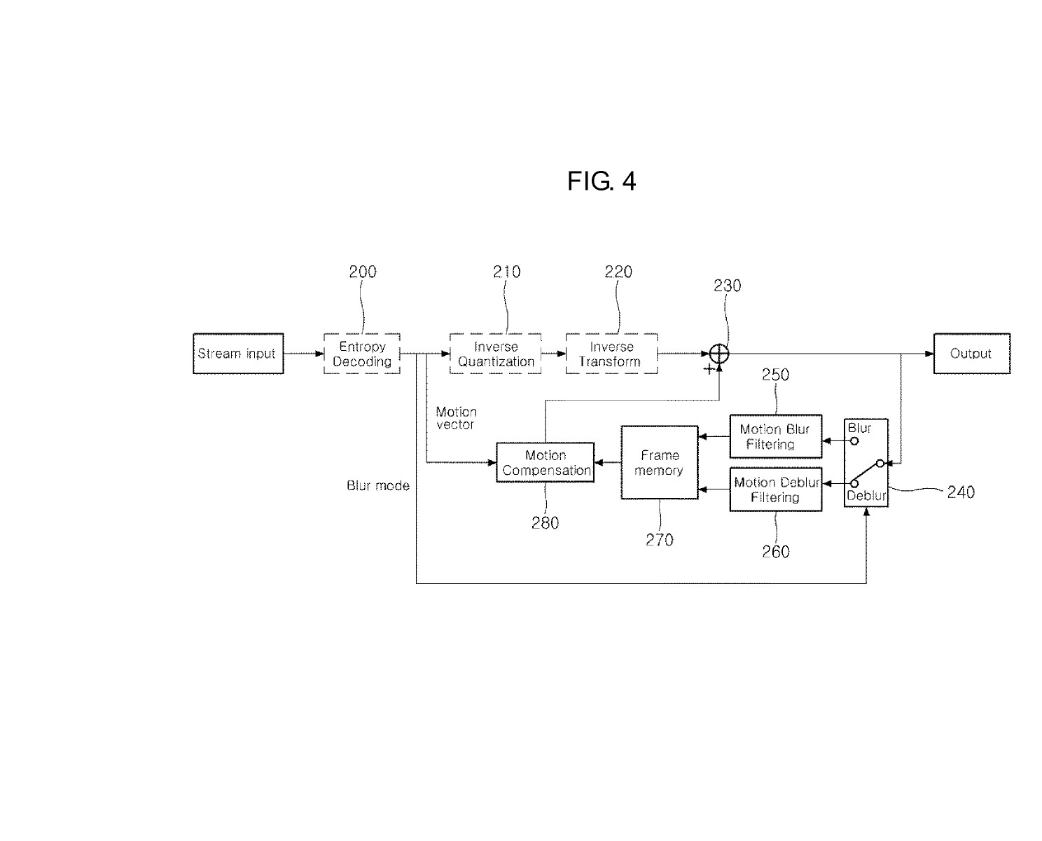

FIG. 4 illustrates a configuration of a video compression decoding device applied with a motion compensation technique using a selective reference frame according to an exemplary embodiment of the present invention.

The video compression decoding device includes a decoding unit 200 to perform entropy decoding on an input stream; an inverse quantization unit 210 to perform inverse quantization on a decoded frame signal from the decoding unit 200; an inverse transform unit 220 to perform a transform, inverse to the transform of the coding process, on the inverse quantized frame signal; an adder 230 to generate a reconstructed frame by adding a motion-compensated frame; a filter selection control unit 240 to extract blur mode information from the decoded frame signal from the decoding unit 200, and generate reference frames by selecting and controlling the motion blur filter 250 or the motion deblur filter 260 using the extracted information; one or more motion blur filters 250 and one or more motion deblur filters 260 configured to generate motion search areas; a plurality of frame memories 270 configured for the motion blur filter 250 and the motion deblur filter 260; and a motion compensation unit 280 to compensate for motion using the motion search areas transferred from the frame memories 270.

As described above, a decoder in accordance with an exemplary embodiment of the present invention compensates for motion by extracting blur mode information input through a coding process on a coded frame signal from the coder in accordance with the exemplary embodiment of the present invention, and generating reference frame (motion search ares) through the extracted information.

A decoding process includes a process of extracting a blur mode from a decoded frame signal; a process of generating motion search areas through the motion blur filter or the motion deblur filter in accordance with information regarding the extracted blur mode; and a process of compensating for motion in accordance with the generated motion search areas.

The decoder decodes an input stream by entropy decoding in the decoding unit 200, and configures a reconstructed frame from a motion-compensated frame by performing inverse quantization and an inverse transform on the decoded input stream.

At this time, the filter selection control unit 240 extracts blur mode information input from a decoded frame signal.

The blur mode information exists in the decoder in a form defined with the coder, whether to perform motion blur filtering or motion deblur filtering from the extracted blur mode information is selected, and the selection of a filter to be applied is determined by obtaining information regarding a motion magnitude (length or intensity), a motion direction (angle), and a type of filter.

From the above-described information, the filter selection control unit 240 obtains new reference frame (motion search areas) to which motion blur noise is added, or from which motion blur noise is removed by performing motion blur filtering or motion deblur filtering on motion search areas of a decoded reference frame, and provides the new reference frame to the motion compensation unit 280.

The motion compensation unit 280 compensates for motion using the above-described reference frame.

What is claimed is:

1. A video compression coding device applied with a motion compensation technique using a selective motion search area in a video coder to which motion compensation using motion estimation is applied, comprising:
one or more motion blur filters and one or more motion deblur filters to generate additional motion search areas with respect to original motion search areas as a unit of block for the motion estimation;
frame memories configured for the motion blur filter and the motion deblur filter respectively;
a motion search area generation control means to generate additional motion search areas of a blur mode with respect to the original motion search areas by selecting the motion blur filter and the motion deblur filter in accordance with a predetermined blur mode;
a motion estimation and mode selection control means to perform motion estimation about the generated motion search areas and the generated motion search area and new added motion search areas, and select the blur mode to be applied to motion compensation by calculating costs of motion estimation processes; and
a motion compensation means to perform motion compensation in accordance with the selected blur mode from the motion estimation and mode selection control means.

2. The video compression coding device of claim 1, wherein the blur mode set in the motion search area generation control means includes information regarding a motion magnitude (length or intensity), a motion direction, and a type of filter.

3. A method of determining a selective motion search area for motion compensation in a motion estimation and compensation process for use in a compression coding device that estimates motion and compensates for the motion in accordance with the estimated motion, comprising:
a blur mode selection process of setting a blur mode for generating additional motion search areas in accordance with motion degrees and angles of an original reference frame, and selecting a motion blur filter and a deblur filter according to the set blur mode;
a filtering process of generating the motion search areas using the motion blur filter and the deblur filter in accordance with the selected blur mode;
a motion estimation process of performing motion estimation about the motion search areas of the original reference frame, and the motion search areas generated through the filtering process; and
a motion compensation process of compensating for the motion by comparing costs occurring after the motion estimation and selecting a blur mode having a minimum value.

4. The method of claim 3, wherein, in the blur mode selection process, wherein the blur mode includes information regarding a motion magnitude (length or intensity), a motion direction, and a type of filter.

5. A video compression decoding device applied with a motion compensation technique using a selective motion search area in a video decoder for performing motion compensation, comprising:
a filter selection control means configured to extract blur mode information from a decoded frame signal, and generate and control motion search areas by selecting a motion blur filter or a motion deblur filter in accordance with information regarding the extracted blur mode information;
one or more motion blur filters and one or more motion deblur filters to generate the motion search areas;
frame memories configured for the motion blur filter and the motion deblur filter respectively; and
a motion compensation means to compensate for motion in accordance with the generated motion search areas.

6. The video compression decoding device of claim 5, wherein the blur mode information includes information regarding a motion magnitude (length or intensity), a motion direction, and a type of filter.

7. A video compression coding and decoding device applied with a motion compensation technique using a selective motion search area for implementing motion compensation through motion estimation,
wherein the video compression coding and decoding device:
generates additional motion search areas by configuring one or more motion blur filters and one or more motion deblur filters with respect to original motion search areas as a unit of block for the motion estimation;
performs motion estimation on each of the generated motion search areas and the additional motion search areas;
compresses and codes a video by calculating costs of motion estimation processes, selecting a motion estimation value to be applied to motion compensation, and performing the motion compensation,
configures one or more motion blur filters and one or more motion deblur filters,
extracts filter information regarding motion blur or motion deblur from the compressed and coded video;
generates the motion search areas by selecting the motion blur filter or the motion deblur filter in accordance with the extracted information; and
decoding the video by compensating for motion from the generated motion search areas.
